(19) United States
(12) Patent Application Publication
(10) Pub. No.: US 2026/0203322 A1
(43) Pub. Date: Jul. 16, 2026

(54) INFORMATION PROCESSING APPARATUS, INFORMATION PROCESSING METHOD, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventor: Taiki HAMADA, Yokohama Kanagawa (JP)

(73) Assignees: KABUSHIKI KAISHA TOSHIBA, Kawasaki-shI (JP); TOSHIBA DIGITAL SOLUTIONS CORPORATION, Kawasaki-shi (JP)

(21) Appl. No.: 19/440,709

(22) Filed: Jan. 6, 2026

(30) Foreign Application Priority Data
Jan. 15, 2025 (JP) 2025-005429

(51) Int. Cl. G06F 16/3329; G06F 16/35

(52) U.S. Cl. CPC G06F 16/33295; G06F 16/35

(57) ABSTRACT

According to one embodiment, an information processing apparatus includes a processor. The processor is configured to acquire first data registered in a database used to generate an answer to a question specified by a user, generate a plurality of chunks by dividing the acquired first data, generate second data representing contents of the acquired first data, generate a plurality of pieces of third data based on combinations of each of the plurality of chunks generated and the generated second data, and register the plurality of pieces of the generated third data in the database.

### CROSS-REFERENCE TO RELATED APPLICATIONS

This application is based upon and claims the benefit of priority from Japanese Patent Application No. 2025-005429, filed January 15, 2025, the entire contents of which are incorporated herein by reference.

### FIELD

Embodiments described herein relate generally to an information processing apparatus, an information processing method, and a storage medium.

### BACKGROUND

In recent years, learning large language models (LLM) using vast amounts of text data can be performed, and generation of answers to questions in natural language using the LLM has been realized.

The above-mentioned LLM can generate appropriate answers to the questions by inputting the questions related to preliminarily learned knowledge (text data). In contrast, when questions on the unlearned knowledge are input, the LLM cannot generate appropriate answers to the questions and a phenomenon referred to as hallucination, i.e., generation of answers that contradict facts may occur.

To generate answers to the questions on the unlearned knowledge, the LLM may use a pre-built database (database containing accumulated knowledge). More specifically, by inputting both the questions about the unlearned knowledge and the data related to the questions retrieved from the database, the LLM can generate appropriate answers even for unlearned topics.

For example, however, when data with low relevance to the questions is retrieved from the database, appropriate answers may not be generated even if the data is input to the LLM. In other words, retrieving the data highly relevant to the questions at high accuracy is required.

### BRIEF DESCRIPTION OF THE DRAWINGS

FIG. 1 is diagram showing an example of a configuration of an information processing system according to a first embodiment.

FIG. 2 is a diagram showing an example of a configuration of the information processing apparatus.

FIG. 3 is a diagram illustrating an overview of an operation of an information processing system.

FIG. 4 is a flowchart showing an example of a procedure of a question answering process.

FIG. 5 is a flowchart showing an example of a procedure of a database construction process.

FIG. 6 is a diagram showing an example of a configuration of an information processing apparatus according to a second embodiment.

FIG. 7 is a diagram illustrating an overview of an operation of an information processing system.

FIG. 8 is a flowchart showing an example of a procedure of a database construction process

### DETAILED DESCRIPTION

In general, according to one embodiment, an information processing apparatus includes a processor. The processor is configured to acquire first data registered in a database used to generate an answer to a question specified by a user, generate a plurality of chunks by dividing the acquired first data, generate second data representing contents of the acquired first data, generate a plurality of pieces of third data based on combinations of each of the plurality of chunks generated and the generated second data, and register the plurality of pieces of the generated third data in the database.

Various embodiments will be described with reference to the accompanying drawings.

### First Embodiment

First, a first embodiment will be described. An information processing apparatus according to the present embodiment corresponds, for example, to a question answering device or a question answer processing device including a function of answering a question specified by a user.

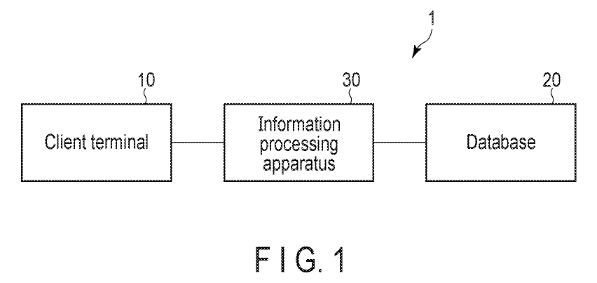

FIG. 1 is diagram showing an example of a configuration of an information processing system according to the present embodiment. As shown in FIG. 1, an information processing system 1 includes a client terminal 10, a database 20, and an information processing apparatus 30.

The client terminal 10 is a terminal apparatus (computer) used by a user who specifies (creates) the above-mentioned question and is connected to the information processing apparatus 30 via a network. The client terminal 10 transmits the question specified by the user to the information processing apparatus 30.

The database 20 corresponds to an information source where various data is stored, and is constructed to be accessible from the information processing apparatus 30 connected via the network. Incidentally, only one database 20 is shown in FIG. 1. However, the information processing apparatus 1 may include a plurality of databases 20.

The information processing apparatus 30 receives questions sent from the client terminal 10 and generates answers to those questions. When generating answers to the above questions, the information processing apparatus 30 uses data matching the questions retrieved from a large language model (LLM) and the database 20. The answers generated by the information processing apparatus 30 are transmitted to the client terminal 10.

In other words, the information processing system 1 in the present embodiment can be considered an interactive computer network system utilizing an LLM.

Incidentally, the information processing apparatus 30 is connected to the client terminal 10 and the database 20 via a network. In this case, the network is, for example, a local area network (LAN), but may also be the Internet, a public communication line, or the like. Furthermore, the connection to the network may be made in a wired or wireless manner.

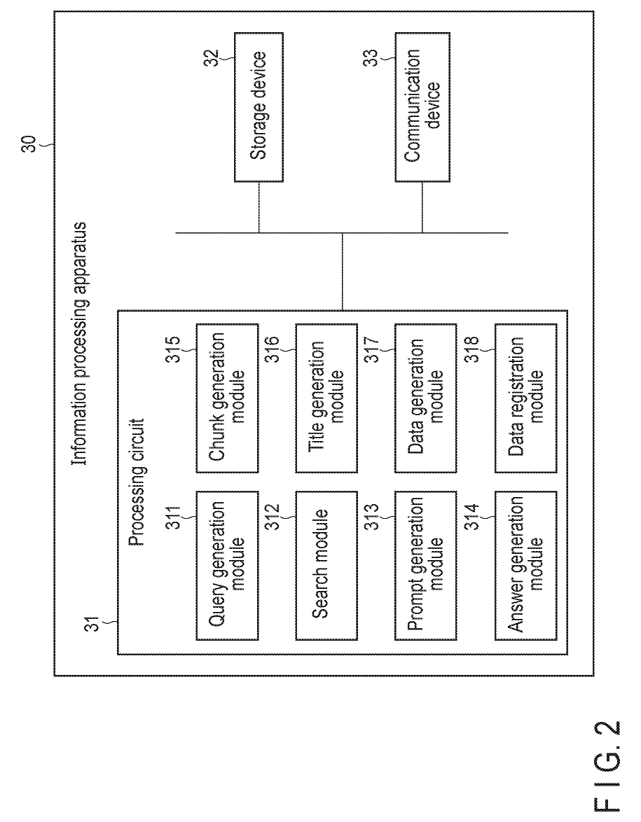

FIG. 2 shows an example of a configuration of the information processing apparatus 30 shown in FIG. 1. As shown in FIG. 2, the information processing apparatus 30 includes a processing circuit 31, a storage device 32, and a communication device 33.

The processing circuit 31 includes, for example, a processor such as a central processing unit (CPU) and a memory such as a random access memory (RAM). Incidentally, the number of processors in the processing circuit 31 may be one or plural.

The storage device 32 corresponds to a non-transitory computer-readable medium and includes, for example, a read only memory (ROM), a hard disk drive (HDD), a solid state drive (SSD), or an integrated circuit storage device. The storage device 32 stores various programs, and the like. The programs stored in the storage device 32 may be implemented as a single program or a plurality of modules divided into predetermined functional units.

The communication device 33 corresponds to an interface for communicating with external devices connected to the information processing apparatus 30 via a network.

It has been described that the information processing apparatus 30 includes the processing circuit 31, the storage device 32, and the communication device 33 in the example shown in FIG. 2. However, the information processing apparatus 30 may further include input devices such as a keyboard, a mouse, various switches, a touchpad, or a touch panel display, and a display device such as a cathode-ray tube (CRT) display, a liquid crystal display, an organic electro luminescence (EL) display, a light-emitting diode (LED) display, a plasma display, or any other display device. Incidentally, the display device may also be, for example, a projector or the like.

As shown in FIG. 2, the processing circuit 31 includes a query generation module 311, a search module 312, a prompt generation module 313, an answer generation module 314, a chunk generation module 315, a title generation module 316, a data generation module 317, and a data registration module 318.

In the present embodiment, each of the modules 311 to 318 is assumed to be realized by a program stored in the storage device 32 being executed by the processing circuit 31 (processor) (i.e., by software).

Incidentally, each of the modules 311 to 318 may also be implemented by, for example, an application specific integrated circuit (ASIC). In this case, the modules 311 to 318 may be implemented on a single integrated circuit or may be implemented separately on a plurality of integrated circuits.

The above-described client terminal 10 includes, as hardware, a processor, a memory, a storage device, a communication device, an input device, and a display device, and functions as a user interface in the information processing system 1. More specifically, the client terminal 10 accepts input of a question specified by the user via the input device. The question is text data corresponding to an inquiry from the user. The question may be a natural sentence such as a question sentence or may be a word such as a search keyword. When the input of the question specified by the user is accepted as described above, the client terminal 10 transmits the question to the information processing apparatus 30.

The information processing apparatus 30 receives the question transmitted from the client terminal 10 via the communication device 33. The query generation module 311 generates a query for searching for data related to the received question, based on the received question.

The search module 312 performs a search on the database 20 using the query generated by the query generation module 311. The search module 312 thereby acquires data matching the query generated by the query generation module 311 (information related to the query) as the search result. Incidentally, the database 20 needs only to be constructed to be capable of searching for the data related to the above- mentioned question. For example, an internal company database, a paper database, or the like can be used as the database 20.

The prompt generation module 313 generates a prompt by integrating the question and the search result from the search module 312 (the data acquired by the search module 312 as the search result).

The answer generation module 314 generates an answer to the above-mentioned question based on the prompt generated by the prompt generation module 313.

The answer generation module 314 in the present embodiment includes the above-mentioned LLM. The LLM is a language model generated by learning a large amount of text data (questions and answers) and is constructed to generate (output) an answer to the question when the question is input based on the learning. In other words, in the present embodiment, the answer generation module 314 can generate an answer to the question by inputting the prompt generated by the prompt generation module 313 (i.e., the question generated from the question and the search result) to the LLM.

As described above, the answer generated by the answer generation module 314 (LLM) is transmitted to the client terminal 10 via the communication device 33. In this case, the client terminal 10 receives the answer transmitted from the information processing apparatus 30 and displays the received answer on the display device included in the client terminal 10. Incidentally, the answer is text data corresponding to the response to an inquiry from the user.

In the present embodiment, as described above, the database 20 is utilized when generating the answer to the question. To improve the accuracy in the answer, it is necessary to register (store) various data in the database 20 as knowledge provided to the LLM. In the present embodiment, the chunk generation module 315, title generation module 316, data generation module 317, and data registration module 318 shown in FIG. 2 correspond to functional modules that perform processing for registering new data in the database 20 (i.e., constructing the database 20).

The chunk generation module 315 acquires data newly registered in the database 20 (hereinafter referred to as target data). The chunk generation module 315 generates a plurality of chunks by dividing the acquired target data. Incidentally, the target data is assumed to be, for example, text data such as a document.

The title generation module 316 generates a title for the target data as data representing contents of the target data.

The data generation module 317 generates a plurality of pieces of data (hereinafter referred to as data for database registration) based on combinations of each of the plurality of chunks generated by the chunk generation module 315 and the title generated by the title generation module 316.

The data registration module 318 registers in the database 20 the plurality of pieces of the data for database registration generated by the data generation module 317.

Incidentally, it has been described that all the modules 311 to 318 are included in a single device (i.e., the information processing apparatus 30) in FIG. 2. However, the modules 311 to 318 may be distributed and implemented in a plurality of apparatuses or some of these modules 311 to 318 may be implemented in the client terminal 10.

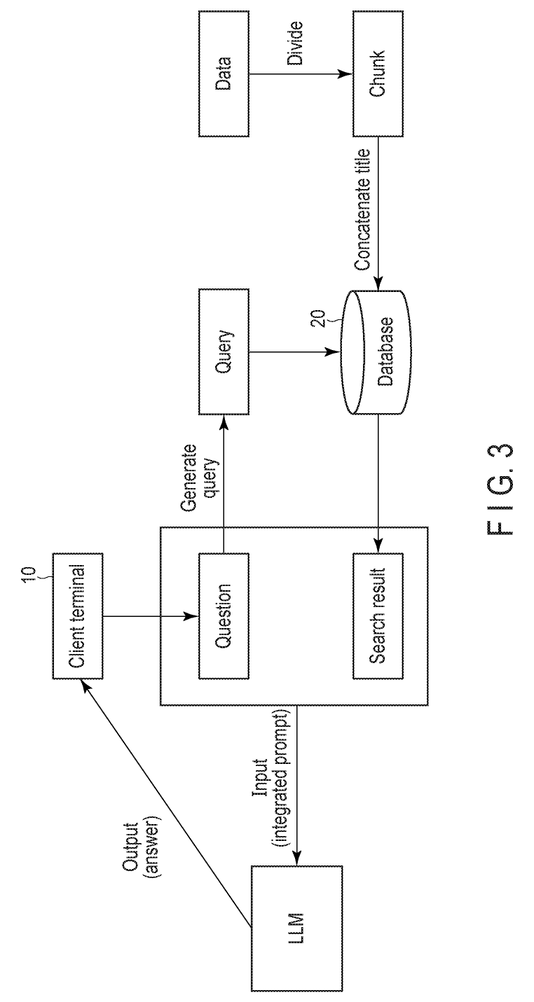

An outline of the operation of the information processing system 1 according to the present embodiment will be described with reference to FIG. 3.

In the information processing system 1 of the present embodiment, searching is performed on the database 20 using the query generated based on the question specified by a user using the client terminal 10, and the search result is obtained.

Incidentally, as mentioned above, when the question is the text data, the query is, for example, a keyword extracted from the question. When the query is thus a keyword, the text data including the keyword is acquired as the search result.

In the present embodiment, by inputting the prompt obtained by integrating the question and the search result (hereinafter referred to as an integrated prompt) to the LLM, the answer to the question output from the LLM is transmitted to the client terminal 10 as the answer.

Furthermore, in the present embodiment, when the data is newly registered in the database 20, the data is divided into a plurality of chunks. Each of the plurality of chunks is registered in the database 20 in a state of being concatenated with the title of the data.

The procedure of the information processing apparatus 30 (processing circuit 31) according to the present embodiment will be described below. A process for generating an answer to a question (hereinafter referred to as a question answering process) and a process for registering new data in the database 20 (hereinafter referred to as a database construction process) will be described.

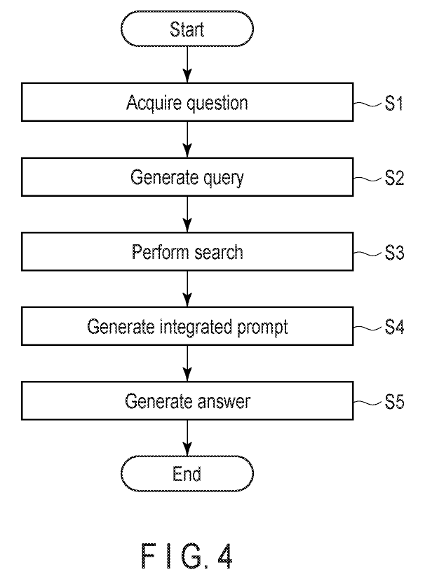

An example of a procedure of the question answering process will be described with reference to a flowchart of FIG. 4. Incidentally, the question answering process is performed when a question transmitted from the client terminal 10 is received by the information processing apparatus 30.

First, the query generation module 311 acquires the question received by the information processing apparatus 30 (step S1).

Next, the query generation module 311 generates a query based on the question acquired in step S1 (step S2). Incidentally, in step S2, the query in a format which allows searching for data related to the question in the database 20 is generated.

The search module 312 performs searching on the database 20 using the query generated in step S2 (step S3).

When the processing in step S3 is executed, the prompt generation module 313 generates the integrated prompt using the question acquired in step S1 and the search result acquired in step S3 (step S4). The integrated prompt is, for example, a prompt in which answering the question using the search result is described, but may be a prompt reflecting both the question and the search result.

Incidentally, in step S4, the integrated prompt may be generated by, for example, inputting the question and the search result to the LLM. The LLM used to generate such an integrated prompt may be the LLM included in the above-mentioned answer generation module 314 (hereinafter referred to as the LLM for answer generation) or may be a different LLM.

When the processing in step S4 is performed, the answer generation module 314 generates the answer to the question using the integrated prompt generated in step S4 and the LLM for answer generation (step S5). In this case, the answer generation module 314 inputs the integrated prompt to the LLM for answer generation to obtain the answer output from the LLM.

Although omitted in FIG. 4, the answer generated in step S5 (i.e., the answer to the question specified by the user) is transmitted from the information processing apparatus 30 (processing circuit 31) to the client terminal 10.

Incidentally, the question answering process described in FIG. 4 is one example, and at least part of the question answering process may be modified. More specifically, at least part of the processing in steps S1 to S5 shown in FIG. 4 may be omitted or replaced with other processing. In addition, processing other than steps S1 to S5 shown in FIG. 4 may be added.

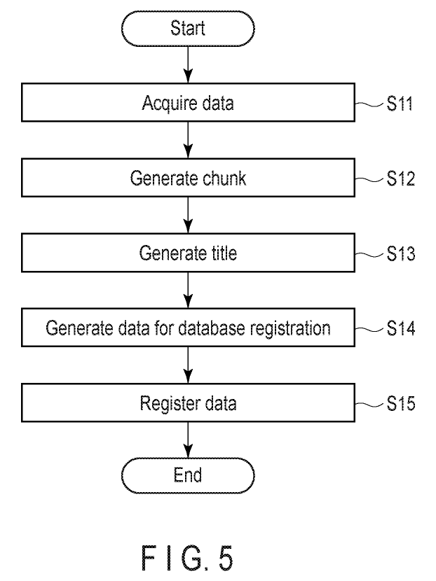

Next, an example of a procedure of the database construction process will be described with reference to a flowchart of FIG. 5.

First, the chunk generation module 315 acquires the target data which is text data newly registered in the database 20 (step S11). The target data may be, for example, data prepared by a user or data created outside the information processing apparatus 30.

Next, the chunk generation module 315 divides the target data acquired in step S11 to generate chunks (step S12). Incidentally, the processing in step S12 corresponds to processing of dividing the target data into a plurality of chunks. Each chunk is a part of the target data obtained by dividing the target data. The plurality of chunks may be generated by dividing the target data according to, for example, a preliminarily determined number of characters or sentences (i.e., a predetermined character count or sentence count). In this case, text data (a part of the target data) composed of the preliminarily determined number of characters or sentences is generated as one chunk. In addition, the plurality of chunks may be generated by, for example, dividing the target data according to the division of the text (document) such as chapters or sections. In this case, text data (a part of the target data) composed of one chapter or section is generated as one chunk.

When the processing in step S12 is performed, the title generation module 316 generates a title for the target data (a document title based on the contents of the target data) acquired in step S11 (step S13).

Incidentally, for example, the title of the target data may be generated based on keywords having high frequency in appearance, which are extracted by performing morphological analysis on the target data, or the like, or may be generated by inputting the target data and a prompt such as “Please generate a concise title that succinctly indicates the contents of the target data” to the LLM (i.e., inquiring the LLM for the title of the target data using this prompt). The LLM used for generating such a title may be the LLM for answer generation or a different LLM. Furthermore, the processing in step S13 may also be the processing of acquiring the title of the target data that has been preliminarily assigned or set to the target data.

Next, the data generation module 317 generates a plurality of pieces of data for database registration, based on the plurality of chunks generated in step S12 and the title generated in step S13 (step S14).

In step S14, the plurality of pieces of the data for database registration are generated by concatenating each of the plurality of chunks with the title. More specifically, if the plurality of chunks include a first chunk and a second chunk, two pieces of data for database registration, i.e., data in which the title is concatenated to a leading part of the first chunk, and data in which the title is concatenated to a leading part of the second chunk are generated in step S14. In other words, the data for database registration in the present embodiment is considered as chunks concatenated to the titles. Furthermore, since the plurality of pieces of data for database registration are generated from single target data item in the present embodiment, the above-described processing in steps S12 to S14 corresponds to a data padding process for the data registered in the database 20.

When the processing in step S14 is performed, the data registration module 318 registers the plurality of pieces of the data for database registration generated in step S14 in the database 20 (step S15).

The database 20 in which the plurality of pieces of the data for database registration have been registered by performing the above-mentioned database construction process, is utilized when performing the above-mentioned question answering process.

Incidentally, the database construction process described in FIG. 5 is one example, and at least part of the database construction process may be modified. More specifically, at least part of the processing in steps S11 to S15 shown in FIG. 5 may be omitted or replaced with other processing. In addition, processing other than steps S11 to S15 shown in FIG. 5 may be added.

As described above, the information processing apparatus 30 according to the present embodiment acquires target data (first data) to be registered in the database used to generate the answer to the question specified by the user, generates a plurality of chunks by dividing the acquired target data, generates the title (second data representing the contents of the first data) for the acquired target data, and generates a plurality of pieces of the data for database registration (third data) based on the combination of each of the plurality of chunks generated and the generated title.

Incidentally, in the present embodiment, the plurality of pieces of the data for database registration can be generated by concatenating the title with each of the plurality of chunks. In addition, the title of the target data (text data) can be generated by, for example, inputting the target data and a prompt requesting the title to the LLM (first language model prepared in advance).

Furthermore, the information processing apparatus 30 according to the present embodiment generates the query to search for the data related to the question, based on the question specified by the user, performs searching on the database 20 in which the data is registered as described above, generates the prompt by integrating the question and the search result, and generates the answer to the question by inputting the generated prompt to the LLM (second language model prepared in advance).

In the present embodiment, the above-described configuration enables improvement of the accuracy in data search in the database 20 used when generating the answer to the question.

For example, when the target data is registered in the database 20 without being divided into chunks, the target data may not be acquired as the search result if the impact of the information on the entire target data is small even if useful information is included in the target data (text data).

In this case, by dividing the target data into a plurality of chunks and registering the chunks in the database 20, it becomes possible to perform searching at the chunk level, thereby increasing the likelihood of searching for the above-mentioned useful information.

However, since the chunks are generated by dividing (information of) the target data, the information of the entire target data is lost in the chunk, and the chunk may not be thereby acquired as the search result (i.e., the accuracy in search may decrease).

Therefore, in the present embodiment, by registering in the database 20 a chunk (i.e., data for database registration) concatenated with the title generated from the entire target data (i.e., title reflecting the overall information in the target data), it becomes possible to search for the chunk while retaining the information of the entire target data, thereby improving the accuracy in data search in the database 20.

Incidentally, it has been described that one title is generated from the target data in the present embodiment, but a plurality of different titles may be generated from the target data. In this case, for each title, a plurality of pieces of the data for database registration can be generated based on the combination of the plurality of chunks and the title. In other words, the plurality of pieces of the data for database registration are generated for all possible combinations of the plurality of chunks and the plurality of titles.

More specifically, for example, if the plurality of chunks are first and second chunks and if the plurality of titles are first and second titles, then four pieces of data for database registration including the data in which the first chunk and the first title are concatenated, the data in which the first chunk and the second title are concatenated, the data in which the second chunk and the first title are concatenated, and the data in which the second chunk and the second title are concatenated, are generated. According to this configuration, oversight of searching for the chunk can be prevented by, for example, concatenating each of the plurality of titles generated from different viewpoints to the chunk.

Incidentally, it has been mainly described that the target data is the text data in the present embodiment, but the target data may be data in a format that is searchable when generating the answer to the question.

Furthermore, concatenating the chunks and the titles has been described in the present embodiment, but the title is merely one example of the data representing the contents of the target data. As long as the information on the subject data (as a whole) can be retained, the data from a viewpoint different from the title may be concatenated with the chunk.

### Second Embodiment

Next, a second embodiment will be described. In the present embodiment, detailed descriptions of the portions like or similar to the above-described first embodiment are omitted and the portions different from those of the first embodiment will be mainly described.

Incidentally, since a configuration of an information processing system according to the present embodiment is the same as that of the above-described first embodiment, the configuration will be described as appropriate with reference to FIG. 1.

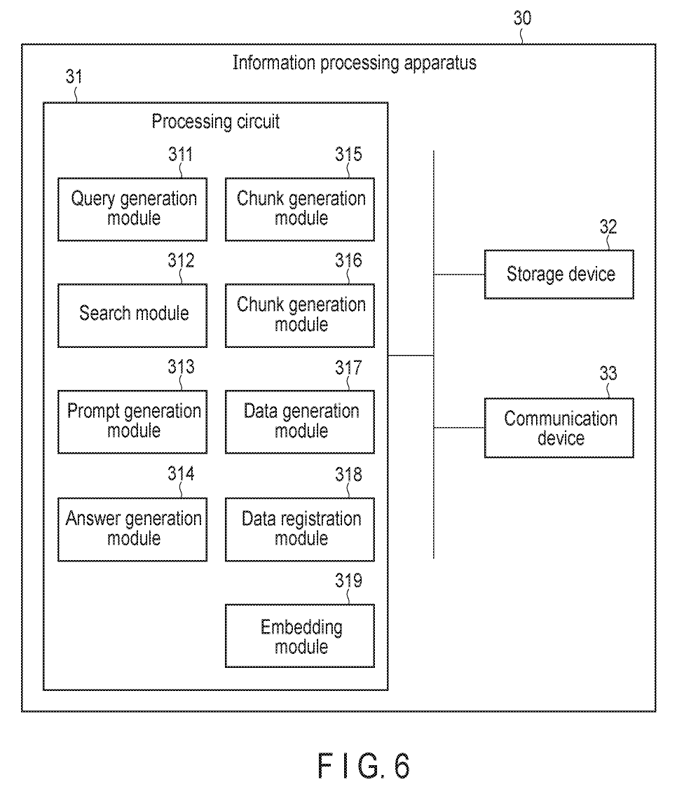

FIG. 6 is a diagram showing an example of a configuration of an information processing apparatus 30 according to the second embodiment. Incidentally, in FIG. 6, portions like or similar to those shown in FIG. 1 are denoted by the same reference numbers and symbols, and their detailed descriptions are omitted.

As shown in FIG. 6, in the present embodiment, the processing circuit 31 includes an embedding module 319 in addition to the modules 311 to 318 shown in FIG. 1.

In the present embodiment, the embedding module 319 is implemented by a program stored in the storage device 32 being performed by the processing circuit 31 (processor) (i.e., software). Incidentally, the embedding module 319 may also be implemented by, example, an application specific integrated circuit.

As described above in the first embodiment, the data generation module 317 generates the plurality of pieces of the data for database registration (chunks with concatenated titles). The embedding module 319 embeds each of the plurality of pieces of the data for database registration in a vector.

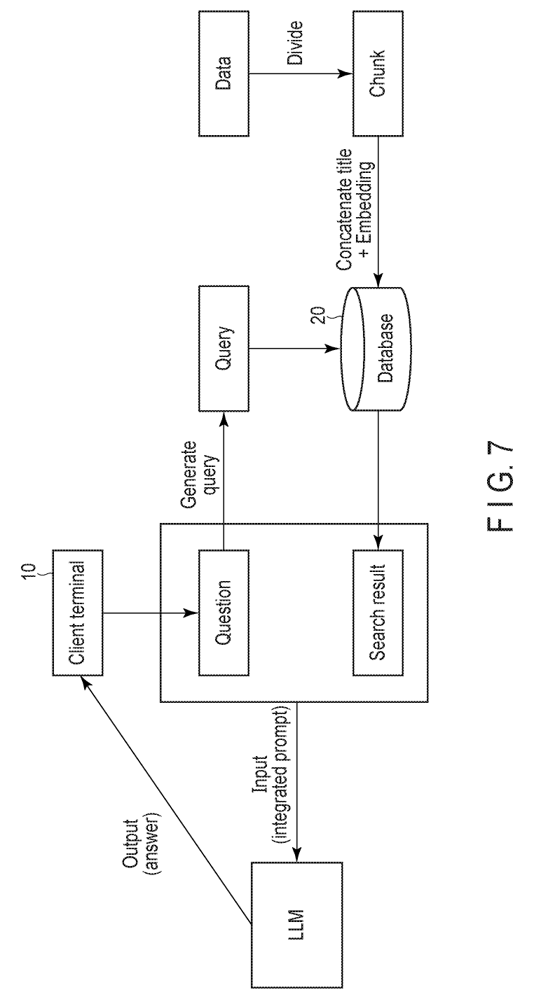

An outline of the operation of the information processing system 1 according to the present embodiment will be described with reference to FIG. 7. Portions different from the above-described portions in FIG. 3 will be mainly described here.

The information processing system 1 in the present embodiment is different from the above-described first embodiment in that each of the plurality of chunks with the concatenated titles is registered in the database 20 in a state of being embedded in a vector.

In other words, the embedding in the present embodiment corresponds to converting the chunk with the concatenated title (i.e., the data for database registration) into a vector representing the data. In the present embodiment, both the data and the vector converted from the data are registered in the database 20 in a manner of being associated with each other.

In the present embodiment, the vectors registered in the database 20 in this manner are used for the data search. More specifically, in the present embodiment, a vector (embedding representation) in which the question is embedded is assumed to be generated as a query based on the question. In other words, the query generation module 311 in the present embodiment embeds the question in the vector when generating the query. According to this, the search module 312 can search for the vectors similar to the query in the database 20 and acquire the data associated with the searched vector as search results.

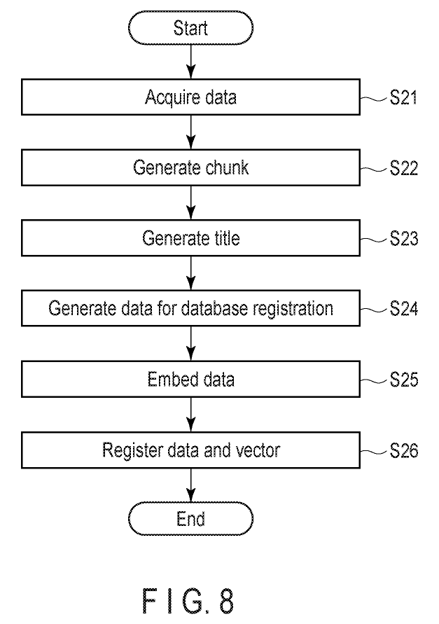

An example of the procedure of the database construction process according to the present embodiment will be described below with reference to the flowchart of FIG. 8.

First, processing in steps S21 to S24 corresponding to the above-described processing in steps S11 to S14 shown in FIG. 5 is performed.

Next, the embedding module 319 embeds each of the plurality of pieces of the data for database registration (chunks with concatenated titles) generated in step S24 in a vector (step S25).

When the processing in step S25 is performed, the data registration module 318 registers the plurality of pieces of the data for database registration and the vectors in which the data is embedded, in the database 20 (step S26).

The database construction process in the present embodiment has been described here. Since the question answering process in the present embodiment is the same as that described above in the first embodiment, except for the generation of the vector (embedding representation) representing the question as the query as described above, its detailed descriptions will be omitted here.

As described above, the information processing apparatus 30 according to the present embodiment enables the data search based on similarity (i.e., semantic similarity) with vectors in which the questions are embedded and enables improves the accuracy in data search in the database 20, by registering the plurality of pieces of the data for database registration and the vectors representing the data in the database 20.

Incidentally, in the present embodiment, the data search in the database 20 is performed using a vector in which the question is embedded (hereinafter referred to as a first query). However, search using keywords extracted from the question (hereinafter referred to as a second query) may be further performed. This configuration may enable further improving the accuracy in data search in the database 20 through a hybrid search combining the search using the first query (search based on similarity of the vectors) and the search using the second query (search using natural language).

More specifically, when using the logical OR of the search results acquired using the first query and the search results acquired using the second query to generate an answer to the question, it is considered possible to prevent oversight in the data search. In contrast, when the logical product of the search results acquired using the first query and the search results acquired using the second query is utilized to generate an answer to the question, it is considered possible to suppress the use of unnecessary data in generating the answer to the question.

According to at least one embodiment described above, it is possible to provide an information processing apparatus, an information processing method, and a program capable of improving the accuracy in data search.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor configured to:
acquire first data registered in a database used to generate an answer to a question specified by a user;
generate a plurality of chunks by dividing the acquired first data;
generate second data representing contents of the acquired first data;
generate a plurality of pieces of third data based on combinations of each of the plurality of generated chunks and the generated second data; and
register the plurality of pieces of the generated third data in the database.

2. The information processing apparatus of claim 1, wherein
the processor is configured to generate the plurality of pieces of the third data by concatenating the second data with each of the plurality of chunks.

3. The information processing apparatus of claim 1, wherein
the processor is configured to:
generate a plurality of pieces of different second data representing the contents of the first data; and
generate the plurality of pieces of third data based on combinations of each of the plurality of chunks with the second data, for each of the pieces of the second data.

4. The information processing apparatus of claim 1, wherein
the first data includes text data,
the second data includes a title of the text data, and
the processor is configured to generate the title of the text data by inputting the text data and a prompt requesting the title of the text data to a first language model prepared in advance.

5. The information processing apparatus of claim 1, wherein
the processor is configured to:
embed each of the plurality of pieces of the generated third data in a vector representing the third data; and
register the plurality of pieces of the generated third data and the vector in which the plurality of pieces of the third data are embedded, in the database.

6. The information processing apparatus of claim 1, wherein
the processor is configured to:
generate a query for searching for data related to the question, based on the question specified by the user;
perform search in a database in which the plurality of pieces of the third data are registered, using the generated query;
generate a prompt obtained by integrating the question and the search result; and
generate an answer to the question by inputting the generated prompt to a second language model prepared in advance.

7. An information processing method performed by an information processing apparatus, the method comprising:
acquiring first data registered in a database used to generate an answer to a question specified by a user;
generating a plurality of chunks by dividing the acquired first data;
generating second data representing contents of the acquired first data;
generating a plurality of pieces of third data based on combinations of each of the plurality of generated chunks and the generated second data; and
registering the plurality of pieces of the generated third data in the database.

8. A non-transitory computer-readable storage medium having stored thereon a program which is executed by a computer, the program comprising instructions capable of causing the computer to execute function of:
acquiring first data registered in a database used to generate an answer to a question specified by a user;
generating a plurality of chunks by dividing the acquired first data;
generating second data representing contents of the acquired first data;
generating a plurality of pieces of third data based on combinations of each of the plurality of generated chunks and the generated second data; and
registering the plurality of pieces of the generated third data in the database.
